(19) United States
(12) Patent Application Publication
(10) Pub. No.: US 2004/0128366 A1
(43) Pub. Date: Jul. 1, 2004

(54) Devices for controlling audio and/or video files and corresponding devices, methods and transmission products

(76) Inventors: Gilles Morillon, Melesse (FR); Nadine Patry, Rennes (FR)

Correspondence Address: Joseph S Tripoli, Thomson Licensing Inc, Patent Operations CN 5312, Princeton, NJ, 08543-0028, US

(21) Appl. No.: 10/468,877

(22) PCT Filed: Feb. 27, 2002
(86) PCT No.: PCT/FR02/00716

(30) Foreign Application Priority Data
Feb. 28, 2001 (FR) 01/02696

(51) Int. Cl. G06F 15/16

(52) U.S. Cl. 709/219; 709/231

(57) ABSTRACT

The present invention relates to a system (3) for ordering audio and/or video files, which system is integrated into a receiver (1) of audio and/or video programs (5), each of the files corresponding to at least one of the programs. This system comprises means of extraction (12) of information relating to the files from the corresponding programs, means of enabling (14) of an order for files and means of triggering (16) of downloading to a recording medium (4) of trains (6) of the files ordered.

The invention is also aimed at a corresponding device and process for broadcasting programs and a corresponding assembly for transmitting trains of files.

Applications to television, radio and home computers.

The present invention concerns a system for ordering audio and/or video files and intended to be integrated into a receiver of audio and/or video programs broadcast in real time, and a corresponding software product and corresponding receiver. It also relates to a device and a process for broadcasting programs and to an assembly for transmitting trains of files. The invention also pertains to an audio and/or video program and to a transport stream, that can be produced with the broadcasting device or the transmission assembly.

It is convenient and nice to be able to order audio and/or video files directly from a receiver of audio and/or video programs. Thus, in patent U.S. Pat. No. 6,067,562 there is proposed a system allowing a user to connect to a database and to a radio station and to select from the database pieces of music that he has heard broadcast on radio. These pieces of music are then sent to him via a communication network, which may be a telephone network or an interactive cable television network.

Patent application WO-00/11871 describes a system allowing a user to request and download files selected from a list of files available from a provider site, via a communications network such as the Internet. The files are downloaded to a local device, such as a television set or audio equipment, where they can be decrypted and decoded, and then be used for a local broadcast (screening and/or listening).

The existing techniques allow a user to obtain remotely the audio and/or video files that he desires, for example after having discovered and appreciated the corresponding programs in the course of a broadcast. However, an order requires several tedious operations on his part. Specifically, in the first place he must go and consult a list of available files, by connecting up to a specified site. In the second place, he must identify the files that he wants to download, this possibly proving to be lengthy and complex if he does not know the precise references of the file or, even if the indications provided are explicit, if he knows only some of the necessary information (for example if he no longer remembers the name of a singer precisely). Finally, he has to enable the order with the provider site, and can then disconnect.

In any event, such approaches are hardly compatible with the monitoring of programs in progress, when a user is concerned with an order relating to one of these programs. He then has to cease monitoring the programs in progress in order to perform the necessary maneuvers, or reissue the order later, taking care to tag all the necessary information and to keep a log thereof.

The present invention relates to a system for ordering audio and/or video files and which is intended to be integrated into a receiver of audio and/or video programs broadcast in real time, which allows a user to place orders for programs received, by means of simple operations requiring no effort of tagging of the wanted files.

The ordering system of the invention also makes possible such orders of broadcast programs, without having to interrupt the monitoring of the programs in progress, nor even to divert his attention by being constrained to concentrate on parallel operations at the same time.

The invention also pertains to a device and to a process for broadcasting programs and to an assembly for transmitting trains of files, making it possible to implement various embodiments of the ordering system of the invention, as well as to a program and a transport stream that can be produced respectively by a broadcasting device and by a transmission assembly in accordance with the invention.

The subjects of the invention are also a software product intended to be integrated into a program receiver and capable of carrying out functionalities of the ordering system of the invention and a program receiver comprising such an ordering system.

It applies in particular to the fields of RF or digital television, RF or digital radio and home computers.

Accordingly, the subject of the invention is a system for ordering audio and/or video files, which system is intended to be integrated into a receiver of audio and/or video programs broadcast in real time. The ordering system comprises:

means of enabling by a user, of an order of at least one of said audio and/or video files,

and means of triggering a downloading to a recording medium of trains of the ordered files, which means are designed to be activated by the enabling means.

According to the invention, each of said audio and/or video files corresponding to at least one of said broadcast audio and/or video programs, said ordering system comprises means of extraction of information relating to said audio and/or video file from any one of the audio and/or video programs corresponding to said file. These means of extraction are coupled with the means of triggering.

The audio and/or video files advantageously consist of audio files, in particular compressed according to an MP3 standard, these files then preferably containing music. The ordering of such a file is done for example during the broadcasting of a video clip on television. The files can also contain audiovisual information, such as films or documentaries.

By contrast with existing systems, a link is directly established by the information extraction means, between a program received and one or more files to be ordered. The establishing of this link can be transparent to the user, who merely has to enable an order.

This system can permit great ease of implementation for a user, who does not have to worry about connecting to a site and tagging from a list of files. Moreover, it allows him to remain in program reception mode, without him having to relax his attention to watch and/or listen to these programs, as would for example be necessary in multi-windowing mode with a window reserved for operations for ordering files.

Relative to direct recording of the programs received, the ordering system of the invention is also very advantageous. Specifically:

it can make it possible to obtain an entire transmission, even if this transmission is already underway when the user connects to the broadcasting channel;

it can make it possible to obtain a file better suited to the desired use than the program itself, for example an MP3 file instead of a recording of a video clip;

it does not require any particular effort of synchronization on the part of the user in order to begin the recording exactly at the start of the broadcast;

it allows the presetting of particular order parameters, for example the systematic ordering of the original version of a film subtitled in French;

it avoids monopolizing the recording device;

and it may require no setting for each recording (in particular the setting of the channel).

The various entities, defined hereinabove or below, included in the ordering system should be understood in a functional sense. Thus, a piece of software or an electronic card can simultaneously undertake several roles, for example include at least some of the functionalities specific to the enabling, triggering and extraction means.

The recording medium is advantageously a hard disk, but may also be a removable medium, such as for example a cassette or an optical disk of the CD or DVD type (the receiver is then furnished with an appropriate writer).

In a first form of recording, this medium is included in the receiver comprising the ordering system, hereinafter referred to as the “ordering receiver”. In a second form of recording, it is exterior to this receiver. The files are then either downloaded directly to the exterior recording medium, for example situated on a local server or another receiver, or downloaded firstly into the ordering receiver and then transferred to an exterior recording medium, for example provided in another receiver. Thus, for example, the ordering receiver is a digital decoder which possesses an interface of the USB or IEEE 1394 type, the MP3 files received possibly being transmitted to an MP3 walkman or to any compatible equipment.

The term “program” is understood within the present application to mean that which contains, in the form of signals, a given transmission, for example a film, a piece of music, a piece of reporting, etc., designed to be broadcast by a broadcasting device and received by a receiver, and permitting real-time broadcasting of this transmission to a user of this receiver. The “program” preferably consists of compressed digital signals, the receiver being provided with a decoder. The broadcasting of the programs can be performed in particular over the airwaves or by cable (for example according to a DVB broadcasting standard), or by a transmission network such as the Internet.

The term “file” is understood to mean a batch of information relating to a given transmission, preferably in compressed digital form, permitting forwarding independently of broadcasting of the transmission in real time. Such forwarding of a file may therefore be much faster than the broadcasting of a corresponding program. The broadcasting of the files may be performed independently or otherwise of the pathway for forwarding the programs, in particular via a messaging network such as the Internet, the airwaves or cable (for example according to a DVB broadcasting standard), as will be detailed hereinbelow.

The expression “an MP3 standard” (MPEG1 Audio Layer 3), is understood to mean the basic MP3 digital audio compression format (launched in 1995), as well as improved later versions of this format, such as the mp3PRO format (launched in 2001).

In a first category of preferred embodiments, the triggering means comprise an addressing module for at least one source capable of providing at least some of said audio and/or video files.

The downloading is then preferably billed source side, as in interactive television systems known to the person skilled in the art. Advantageously, the users are client subscribers to such a service and the source of files possesses a device for identifying the clients during connections. Each download is for example billed the cost of a telephone conversation.

Thus, in a first form of this first category, at least some of the broadcast audio and/or video programs being carriers of signals identifying the audio and/or video files corresponding to said programs, the means of extraction are designed to extract said information from said identifying signals and to transmit said information to the triggering means.

This embodiment therefore requires an adaptation at the level of the program transmission device. The identifying signals for a given program contain for example the address of a data server capable of providing the file (or the files) associated with the program and the references (identifying code) of this file.

Preferably in this first embodiment, said identifying signals containing at least one address of at least one server capable of providing said audio and/or video files associated with said identifying signals:

the means of extraction are designed to extract said addresses of servers and to transmit said addresses to the triggering means,

and the addressing module is designed to request said audio and/or video files associated with said identifying signals from said servers.

In a variant embodiment, the source of the files is predefined at the level of the addressing module, in such a way that the identifying signals do not contain server addressing information.

According to a second preferred embodiment of the first category, the information extraction means comprise a module for automatic recognition of at least some of said audio and/or video programs and a module for allocation of said information relating to said programs, which module is coupled to the automatic recognition module.

The information extraction means therefore automatically determine the information regarding the files to be ordered, without specific identifying signals being contained in the programs received. No particular adaptation is thus required at the level of the program transmission devices. On the other hand, the ordering system is more complex.

A beneficial deployment of this second embodiment relies on the use of an electronic program guide or EPG. Such a guide makes it possible indeed to ascertain the schedules for the programs received on the various channels (TV or radio).

In a particular implementation, the module for allocating the information receives beforehand addressing information for various files associated with programs indicated by the EPG and stores them in a memory. This information is for example communicated to it via a messaging network such as the Internet, or else by a particular transmit channel. During the reception of programs concerning a user, the automatic recognition module is then capable of determining the program broadcast, in conjunction with the EPG, then of verifying at the information allocation module that file addressing information is available for this program. If such is the case, the allocation module provides the information required. By way of example, the programs are broadcast on TV (films, reports, debates, etc.) and the downloading of the addressing information is performed at a rate of once a day to once a week. In another example, the programs are video clips broadcast on TV or pieces of music broadcast on radio, and the downloading of the addressing information is performed at a rate of once an hour to once a day.

As a variant, the addressing information is not downloaded, but is available directly at the EPG. In another variant, no EPG is used by the ordering system and the downloaded addressing information contains all the useful information, in particular relating to the schedules and to the channels.

In a second category of preferred embodiments, said receiver being capable of receiving trains of at least some of said audio and/or video files broadcast in real time at the same time as the audio and/or video programs corresponding to said files, the triggering means are capable of causing a branching of said receiver onto said trains of files corresponding to said programs, in such a way as to permit downloading of said audio and/or video files by means of said trains.

Thus, in contradistinction to the embodiments of the first category, the files are not obtained by addressing of a source, but are received in parallel with the corresponding programs, and are therefore permanently available directly at the receiver level. It is thus unnecessary to implement a request for downloading via a messaging network to retrieve the files. On the other hand, particular provisions must be made at the transmit level, so that the files are transmitted synchronously with the broadcasting of the associated programs.

Preferably, said audio and/or video programs being carriers of link signals tied with said trains of files, the means of extraction are designed to extract said link signals.

According to other embodiments, the information extraction means comprise an automatic recognition module and an information allocation module, as in the second form of the first category.

The downloading of files is preferably billed through a system of tokens, according to techniques known to the person skilled in the art in respect of purchasing of films on digital bouquets.

According to a first particular form of this second category, the file trains and the programs reach the ordering system in multiplexed form, in same transport streams or TS. The program link signals are then indicators making it possible to distinguish in each TS the packets relating to the programs and the packets relating to the files (the two types of indicators conventionally being regarded as incorporated into the programs) and the branching module has a demultiplexing function. This form is fast since it requires no change of frequency. Sophisticated functionalities must however be provided in the program broadcasting device.

According to a second form of this second category, the file trains and the programs reach the ordering system separately and synchronized, preferably on one and the same digital bouquet, and the decoder possesses two tuners. The user can then continue to monitor the program in progress while the file is decoded and recorded.

According to a third form of this second category, said receiver comprises a digital decoder and a switching block intended to toggle said decoder from at least one of said audio and/or video programs to the transmission of files corresponding to this audio and/or video program when the triggering means are activated by the enabling means and to toggle said decoder from this transmission to this program when the downloading of the file associated with the program is completed. This embodiment is used in the presence of a single tuner associated with the decoder. During downloading, the broadcasting of the program to a user is temporarily interrupted, a standby screen being for example presented to him.

For the second and the third forms of the second category, the programs and the files are broadcast respectively according to two distinct channels. The receiver (for example a decoder) is connected to the file transmit channel during a download, either as a supplement to the connection on the programs channel (second form), or by toggling or hopping from one to the other (third form).

For example, a channel (such as a DVB service) adjoining a main channel broadcasting video clips is dedicated entirely to the broadcasting of MP3 chunks. The entire bandwidth of the channel is thus reserved for the loop-wise broadcasting of MP3 files, no audio and/or video train being broadcast therein.

The various embodiments of the first and of the second category are advantageously combined, the ordering system thus having the capacity to be compatible with several techniques for interrelating programs and files.

Preferably, the ordering system comprises means of production of messages addressed to a user, said messages indicating to said user during receptions of said audio and/or video programs that the enabling means can be used.

Thus, for TV programs, the user is advantageously advised of the possibility of ordering a file (music or film for example) by the appearance on the screen (above the video) of a small file ordering window, or teaser. Simply by pressing an enabling key of a remote control (single click), the user then triggers the downloading of the appropriate file. Preferably, the ordering window is supplemented with a small abandon window, for clearing the displays from the screen.

For a radio, the message production means are advantageously designed to activate the lighting up and flashing of a light-emitting diode or LED. The enabling means are then advantageously linked to a download key.

Through a home computer, the message production means advantageously cause the displaying, alongside a program reception window, of a download button.

Preferably, the ordering system comprises means of ordering recording on the recording medium, of the downloaded audio and/or video files, said means of ordering recording being designed to supplement said files with details regarding the corresponding audio and/or video programs and/or regarding conditions of downloading of said files.

The added details pertain for example to the content of the files associated with the programs: title, composer, artist, duration . . . for a piece of music; title, director, actors, year, language, duration . . . for a film. They also indicate, advantageously, the downloading conditions: date of download, type of file (example: MP3) and possibly origin of the file.

The invention also relates to a device for broadcasting audio and/or video programs. According to the invention, this device comprises means of incorporation into said audio and/or video programs of signals identifying audio and/or video files corresponding to said programs.

Such a device is preferably intended to cooperate with a file ordering system in accordance with the first form of the first category of embodiments of the invention. According to other applications, the identifying signals are designed to be recorded automatically in a readable or audible form in databases of the receivers, in such a way as to permit a user to subsequently place orders on the basis of the list of files.

The invention also relates to a transmission assembly for transmitting trains of audio and/or video files. According to the invention, this transmission assembly comprises:

means of transmission of trains of audio and/or video files corresponding to transmitted audio and/or video programs,

and means of synchronization cooperating with the means of transmission, and capable of managing the transmission of said files in such a way that the trains of files are transmitted at the same time as said corresponding programs.

Such a device is preferably intended to cooperate with a system for ordering files in accordance with the second category of embodiments.

Preferably, this transmission assembly is designed to transmit in a loop during the broadcasting of each of said programs, said audio and/or video file corresponding to said program. By virtue of this loop-wise or “carousel” transmission, the downloading can be performed throughout the broadcasting of the program.

For example, the transmission assembly transmits loop-wise music files MP3, in synchronization with the broadcasting by broadcasting means, of video clips associated with these files. Given that:

the average duration of a video clip is 3 minutes,

the size of a corresponding MP3 file of CD quality is 3 Mbytes,

and the throughput of a modest service is 0.5 Mbytes/s,

the average duration of transmission, hence of downloading, of a chunk coded in MP3 is 6 seconds. An MP3 file is therefore broadcast 30 times during the broadcasting of the corresponding clip. The user can thus choose to download this chunk at any time in the course of the broadcasting of the clip. Even if the clip is nearly finished (up to 6 seconds from the end), it is not too late.

Additionally, the transmission assembly advantageously comprises means of broadcasting of said audio and/or video programs and means of multiplexing cooperating with the means of transmission of the trains of files and the means of broadcasting of the programs, intended to multiplex the audio and/or video programs and the corresponding files on same transport streams.

The programs and the corresponding files may thus be reconstructed without it being necessary to change frequency, hence faster, preferably by means of an ordering system in accordance with the second form of the second category of embodiments.

The invention also applies to a software product intended to be integrated into a receiver of audio and/or video programs broadcast in real time. According to the invention, the software product contains extraction functionalities for information relating to audio and/or video files corresponding to said audio and/or video programs, capable of embodying the means of extraction of information of an ordering system in accordance with any one of the embodiments of the invention.

The expression “software product” is understood to mean the materialization of a piece of software or computer program, in particular on a medium, such as for example disk, diskette or cassette, or in signal form, for example for Internet downloading.

The invention applies also to an audio and/or video program. According to the invention, this program is a carrier of signals identifying at least one audio and/or video file corresponding to said program.

Said audio and/or video program is preferably obtained by means of a broadcasting device in accordance with the invention and/or intended for an ordering system in accordance with the first form of the first category of embodiments.

Another subject of the invention is a transport stream. According to the invention, it contains a multiplexing of at least one audio and/or video program and of at least one audio and/or video file corresponding to said program.

This transport stream is preferably obtained by means of a transmission assembly in accordance with the invention and/or intended for an ordering system in accordance with the first form of the second category of embodiments.

The invention also applies to a receiver of audio and/or video programs. According to the invention, this receiver comprises an ordering system in accordance with the invention. The receiver is advantageously chosen from among an RF or digital television, an RF or digital radio, a home computer and a digital decoder.

By way of first example, the receiver is a television or a computer on which a user watches video clips. When he likes a song and when a “MP3” teaser is displayed, the user can click on the teaser and is offered the option of immediate or later downloading of the song. Depending on the choice made, an MP3 audio file is then deposited on a storage unit of the receiver, carrying the information “Artist-Name of the song-Date of downloading”.

In a second example, the receiver is an analog radio.

The user connects up to a channel and wants to record a song that is currently being broadcast. If an LED indicator is flashing, a simple press of a download key then allows him to retrieve the whole of the MP3 version of the song.

Moreover, the receiver preferably comprises a management system for managing the files downloaded into the recording medium. Said management system is designed:

to automatically add the downloaded files to at least one list consultable by a user,

to permit deletions of the files contained in said list, by said user,

and to permit reading of each of the files contained in said list, on request from said user.

The term “reading” of a file is understood to mean its possible decoding and its broadcasting by the receiver in audio and/or video form, either directly to the user (a piece of music is played, a film is shown on the screen etc.), or by transmission to an exterior device.

The receiver can thus be utilized as a database of files. For example a television is used as a jukebox to play recorded pieces of music.

The invention relates moreover to processes for broadcasting an audio and/or video program.

According to a first of these processes, at least one signal identifying at least one audio and/or video file corresponding to said program is incorporated into said program before broadcasting. This process is preferably intended for an ordering system in accordance with the first form of the first category of embodiments.

According to a second of these broadcasting processes, before broadcasting, said audio and/or video program is multiplexed with at least one audio and/or video file corresponding to said program. This process is preferably intended for an ordering system in accordance with the first form of the second category of embodiments.

The invention will be better understood and illustrated by means of the following wholly unlimiting exemplary embodiments and implementations, with reference to the appended figures in which:

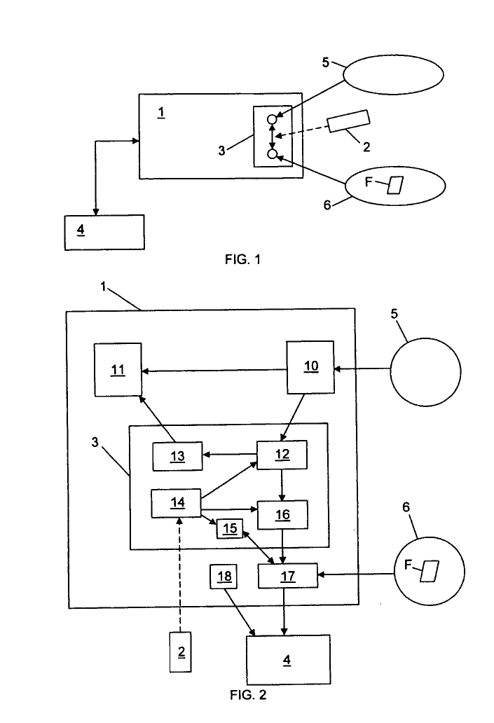

FIG. 1 is a basic diagram of a receiver according to the invention, associated with a storage system;

FIG. 2 represents a system for ordering files included in the receiver of FIG. 1, as well as other elements of this receiver that are coupled to the ordering system;

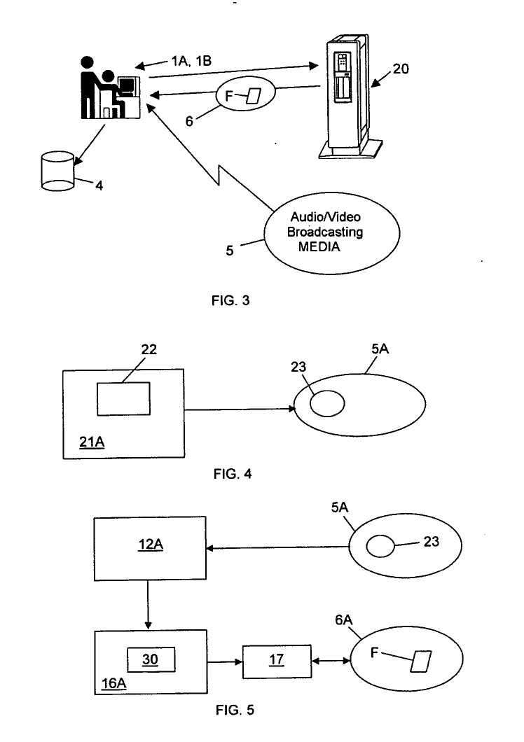

FIG. 3 illustrates an application of a first category of embodiments of the ordering system;

FIG. 4 shows a broadcasting device used in a first form of embodiments of FIG. 3;

FIG. 5 shows significant elements of a receiver used in the first form of embodiments of FIGS. 3 and 4;

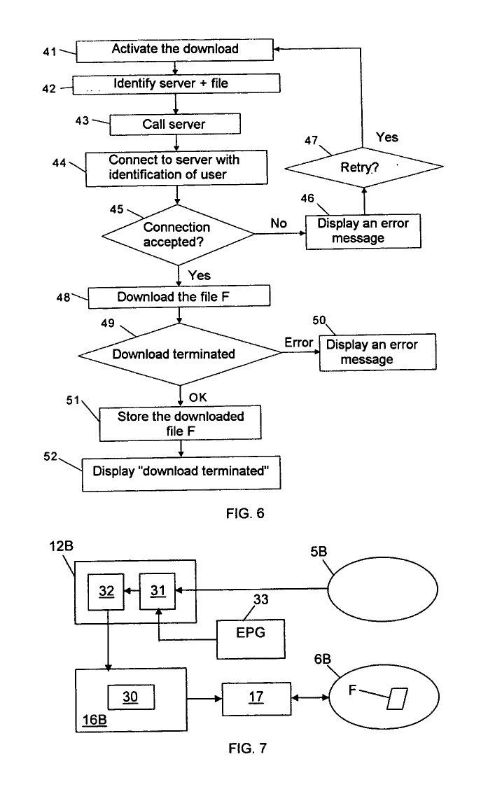

FIG. 6 gives a flowchart of operations performed according to the first form of embodiments, illustrated in FIGS. 3 to 5;

FIG. 7 shows significant elements of a receiver used in a second form of embodiments of FIG. 3;

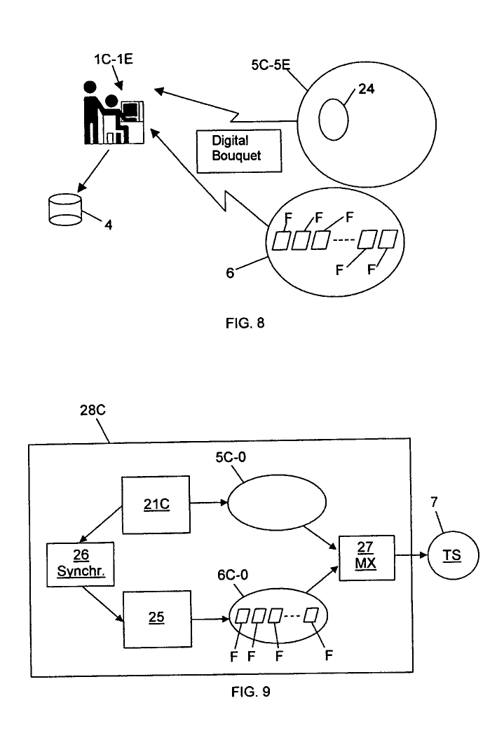

FIG. 8 illustrates an application of a second category of embodiments of the ordering system;

FIG. 9 shows a transmission assembly used in a first form of embodiments of FIG. 8;

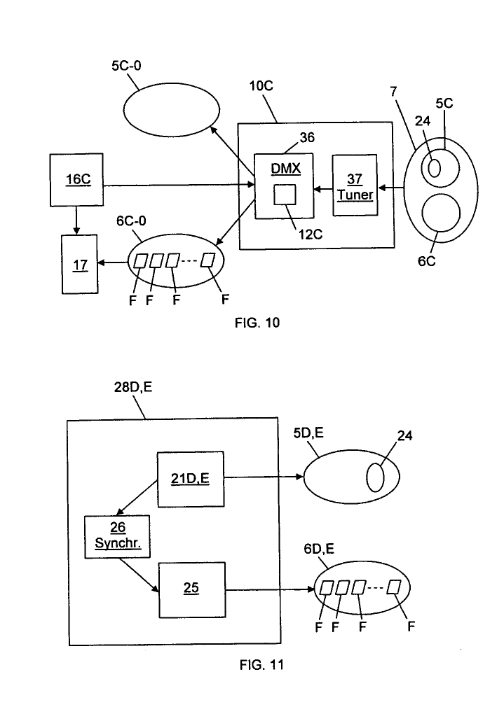

FIG. 10 shows significant elements of a receiver used in the first form of embodiments of FIGS. 8 and 9;

FIG. 11 shows a transmission assembly used in a second and a third form of embodiments of FIG. 8;

FIG. 12 shows significant elements of a receiver used in the second form of embodiments of FIGS. 8 and 11;

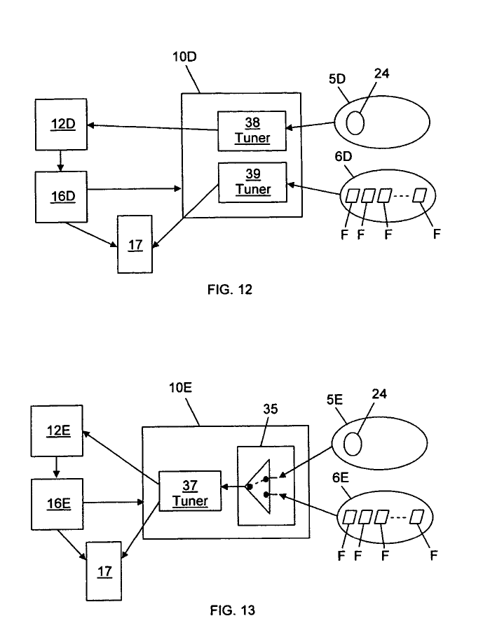

FIG. 13 shows significant elements of a receiver used in the third form of embodiments of FIGS. 8 and 11;

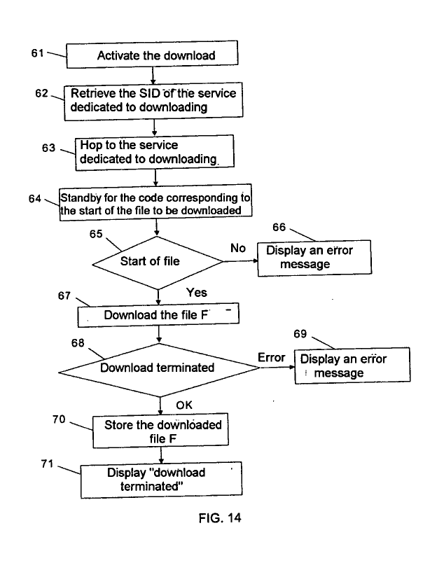

and FIG. 14 gives a flowchart of operations performed according to the third form of embodiments illustrated in FIGS. 8, 11 and 13.

In the various embodiments described, identical or similar entities are designated by one and the same reference. When corresponding entities differ significantly in certain embodiments relative to other embodiments, the generic reference of all these entities consists of one and the same numerical value, and the particular references associated with the various embodiments consist respectively of this numerical reference followed by alphabetic suffixes (A-E).

In the drawings, only the elements significant for the account of the invention are represented.

A television constituting a receiver 1 of audiovisual programs 5 broadcast in real time (FIG. 1) comprises a system 3 for ordering audio and/or video files F. The receiver 1 is coupled to a storage system 4 for recording the downloaded files F. The ordering system 3 allows a user of the receiver 1 to trigger the downloading of a train 6 of one or more files F corresponding to a transmission in progress, by simple enabling by means of a remote control 2. In the examples described, the programs and the files are in compressed digital form.

More precisely (FIG. 2), the receiver 1 comprises means of reception 10 of programs 5, comprising a modem and a decoding unit, means of broadcasting 11 on the screen of the decoded programs 5 and means of downloading 17 the files F to the storage system 4. Moreover, a management system 18 is devoted to the management of one or more lists of downloaded files F: consultation by a user, addition or deletion of files, initiation of reading of one of the files F on request from the user (including the decoding). For the sake of simplicity, the links between the storage system 4 and the management system 18 on the one hand, and the decoding means (reception means 10) and the broadcasting means 11 on the other hand, are not represented in FIG. 2.

The file ordering system 3 has in particular the function of determining the necessary information for ordering one or more files F corresponding to a transmission watched by a user, on the basis of this transmission itself. For this purpose it comprises information extraction means 12 linked to the reception means 10, that can be actuated by enabling means 14, it being possible to initiate the latter by pressing a key of the remote control 2 (of the “OK” key type). The extraction means 12 are linked to download triggering means 16 included in the ordering system 3, and capable of acting on the downloading means 17.

Moreover, the ordering system 3 comprises recording ordering means 15 coupled to the downloading means 17, intended for supplementing the files F recorded in the storage system 4 with various details relating to the corresponding programs 5 (title, author/director, duration . . . ) and to the downloading conditions (date, source of the files . . . ). These details may be obtained in essence directly in the downloaded files F. In a variant embodiment, some of the information emanates from the extraction means 12. Other details, such as the date, may also be obtained otherwise (local schedule).

The ordering system 3 also comprises message production means 13 linked to the broadcasting means 11. These message production means 13 are intended to make an ordering window appear on the screen of the receiver 1. For example, this window is a teaser appearing in a corner of the television screen, superimposed on the broadcast image.

In a first variant, the receiver 1 is a home computer, the remote control 2 being replaced with a mouse or a trackball. Messages with ordering screens are then for example displayed in a small window neighboring a window for displaying the programs received.

In a second variant, the receiver 1 is a radio, the remote control 2 being replaced with a download button. The messages are then for example addressed to a listener in the form of the flashing of an LED.

Several specific embodiments will now be detailed. In a first category of embodiments (FIG. 3), the receiver 1, referenced 1A or 1B, orders the identified files F, from a data server 20. The transfers between the receiver 1 and the server 20 are performed for example via electronic messaging such as the Internet.

According to a first form of this first category (FIGS. 4 to 6), the programs 5, referenced 5A, received by the receiver 1A are carriers of identifying signals 23 giving all the information necessary for obtaining the appropriate files F: address of the server 20 and identifier codes for the files F. Such signals 23 are incorporated into the programs 5 by a broadcasting device 21A (FIG. 4). The information extraction means 12A (FIG. 5) are then capable of extracting the identifying signals 23 and the download triggering means 16A comprise an addressing module 30, capable of requesting the files F associated with the identifying signals 23 from the server 20, in the form of trains 6A.

While operational, the following steps are executed in succession (FIG. 6);

activation of the downloading by the enabling means 14 (step 41);

identification of the server 20 and of the file F to be downloaded by the information extraction means 12 (step 42);

call of the server 20 by the downloading means 17 (step 43);

connection to the server 20 with identification of the user of the receiver 1 (step 44);

test of connection (step 45): if connection is denied, display of an “unreferenced user at server level” error message (step 46) and retry prompt (step 47);

if the connection is accepted, downloading of the file F (step 48);

test of end of download (step 49): if an error is detected, display of an “a download error has occurred” error message (step 50);

if the download terminates normally, storage of the downloaded file F in the storage means 4 (step 51);

display “download terminated” (step 52).

According to a second form of this first category (FIG. 7), the programs 5B received by the receiver 1B have not been subjected to any particular processing. The information extraction means 12B comprise an automatic recognition module 31 linked to an EPG 33, and an information allocation module 32. The recognition module 31 automatically recognizes the transmissions received, by making use of the EPG 33 which provides it with the necessary indications regarding the channels and the schedules, and the allocation module 32 associates with the transmissions thus identified the information required for the downloads. This information has been provided beforehand to the allocation module 32. In a variant embodiment, it is available directly at the EPG 33. The triggering means 16B are then able to instigate the downloading of the file trains 6B.

In a second category of embodiments (FIG. 8), the receiver 1 referenced 1C, 1D or 1E receives not only the programs 5C-5E but also, synchronously, the trains 6 of corresponding files F. No request to a data source is then necessary in order to obtain the files F, the latter being available directly at the receiver 1. For example, the files F are broadcast on a DVB channel dedicated entirely to the transmission of files. The files F are transmitted carousel-wise in the trains 6, one and the same file being transmitted repeatedly in the course of time throughout the duration of broadcasting of the corresponding program.

In the examples described, the programs 5C-5E include link signals 24 tied to the trains 6C-6E of the associated files F. The information extraction means 12 are then capable of identifying these links and of sending the download triggering means 16 the information necessary for branching to the transmissions of the files F. In another embodiment, such link signals 24 are absent from the programs 5, and the information extraction means 12 have similar functionalities to those of the extraction means 12B of the second form of the first category (FIG. 7).

According to a first form of this second category (FIGS. 9 and 10), the programs 5C and the file trains 6C are transmitted in the form of multiplexed trains 7 by a transmission assembly 28C. The transmission assembly 28C comprises means of broadcasting 21C of the programs 5, referenced 5C-0, means of carousel-wise transmission 25 of the trains 6 of the files F, referenced 6C-0, and means of synchronization 26 of the two broadcasting devices. The latter make it possible to ensure that the files F are actually delivered during the broadcasting of the corresponding programs 5. The transmission assembly 28C also comprises means of multiplexing 27 of the programs 5C-0 and of the trains 6C-0 of files, to form the multiplexed trains 7. Each of these multiplexed trains 7 consists of a transport stream containing program packets 5C and also file trains 6C.

The link signals 24 are then implicitly present in the programs 5C of the multiplexed trains 7 obtained, in particular by the identifiers of the headers of each packet.

The receiver 1C (FIG. 10) has its reception means 10, referenced 10C, which comprise a demultiplexer 36 at the output of a tuner 37. The demultiplexer 36 is intended for extracting from the multiplexed train 7 received by the tuner 37 the programs 5C-0 and the trains 6C-0 of the files F, and therefore comprises the means of extraction 12C of information of the ordering system 3. These means of extraction 12C are in particular intended for identifying start and end of file codes. On action of the triggering means 16C, the multiplexer 36 provides the downloading means 17 with the trains 6C-0 so that the files F are stored.

According to a second and a third form of this second category (FIGS. 11 to 14), the programs 5D or 5E and the trains 6D or 6E are transmitted separately, respectively by broadcasting means 21D-21E and by transmission means 25 controlled by synchronization means 26, of a transmission assembly 28D or 28E (FIG. 11). The broadcasting means 21 then incorporate link signals 24 into the programs 5 transmitted, the former including an identifier for branching to the trains 6. For example, the programs 5 are broadcast on a first DVB service and the trains 6, on a second DVB service, on one and the same digital bouquet. In this case the link signals 24 contain the SID (Service Identifier) of the second service.

In the second embodiment (FIG. 12), the means of reception 10D comprise two tuners 38 and 39 designed to receive the programs 5D and the file trains 6D respectively. The information extraction means 12D are capable, on request from a user, of obtaining the link signals 24 in the programs 5D and of forwarding to the download triggering means 16D the details necessary for the branching of the second tuner 39 onto the transmissions of the files F. The triggering means 16D are designed to then cause the correct branching of the tuner 39 and the downloading of the files F to the downloading means 17, then the storage system 4.

In the third embodiment (FIG. 13), the reception means 10E comprise a single tuner 37, downstream of a switching block 35. The latter is intended to be connected to the programs 5E when a user is watching transmissions and to toggle to the trains 6E of files F during the downloading of files. Thus, the tuner 37 being in programs 5E reception mode, the information extraction means 12E are capable of obtaining on request from a user the link signals 24 in the programs 5E and of forwarding to the download triggering means 16E the details necessary for the branching of the tuner 37 onto the transmissions of the files F. The triggering means 16E can then act on the switching block 35 to place the tuner 37 in file trains 6E reception mode and to correspondingly trigger the downloading of the files F to the downloading means 17, then the storage system 4.

During operation, the following steps are executed in succession (FIG. 14):

activation of the download by the enabling means 14 (step 61);

retrieval of the SID of the service dedicated to the downloading by the extraction means 12E (step 62);

hopping of the switching block 35 onto the service dedicated to downloading (step 63);

standby for the code corresponding to the start of the file F to be downloaded (step 64);

test of detection of start of file (step 65): if detection is not effected, display of an error message “The download deadline for this piece of music has expired: do you want to program a download during a rebroadcast?” (step 66);

if the start of file is detected, downloading of the file F (step 67);

test of end of download (step 68): if an error is detected, display of an “a download error has occurred” error message (step 69);

if the download terminates normally, storage of the downloaded file F in the storage means 4 (step 70);

display “download terminated” (step 71).

1. A system (3) for ordering audio and/or video files (F) advantageously consisting of audio files compressed according to an MP3 standard, which system is intended to be integrated into a receiver (1) of audio and/or video programs (5) broadcast in real time, said ordering system (3) comprising:
means of enabling (14) by a user, of an order of at least one of said audio and/or video files (F),
and means of triggering (16) a downloading to a recording medium (4) of trains (6) of said ordered files (F), which means are designed to be activated by the enabling means (14),
characterized in that each of said audio and/or video files (F) corresponding to at least one of said broadcast audio and/or video programs (5), said ordering system (3) comprises means of extraction (12) of information relating to said audio and/or video file (F) from any one of said audio and/or video programs (5) corresponding to said file (F), said means of extraction (12) being coupled with said means of triggering (16).

2. The system as claimed in claim 1, characterized in that the triggering means (16A, 16B) comprise an addressing module (30) for at least one source (20) capable of providing at least some of said audio and/or video files (F).

3. The system as claimed in claim 2, characterized in that at least some of the broadcast audio and/or video programs (5A) being carriers of signals (23) identifying the audio and/or video files (F) corresponding to said programs (5A), the means of extraction (12A) are designed to extract said information from said identifying signals (23) and to transmit said information to the triggering means (16A).

4. The system as claimed in claim 3, characterized in that said identifying signals (23) containing at least one address of at least one server (20) capable of providing said audio and/or video files (F) associated with said identifying signals (23):
the means of extraction (12A) are designed to extract said addresses of servers (20) and to transmit said addresses to the triggering means (16A),
and the addressing module (30) is designed to request said audio and/or video files (F) associated with said identifying signals (23) from said servers (20).

5. The system as claimed in any one of claims 2 to 4, characterized in that the information extraction means (12B) comprise a module for automatic recognition (31) of at least some of said audio and/or video programs (5B) and a module (32) for allocation of said information relating to said programs (5B), which module is coupled to the automatic recognition module (31).

6. The system as claimed in any one of the preceding claims, characterized in that said receiver (1C) being capable of receiving trains (6C-6E) of at least some of said audio and/or video files (F) broadcast in real time at the same time as the audio and/or video programs (5C-5E) corresponding to said files (F), the triggering means (16C-16E) are capable of causing a branching of said receiver (1) onto said trains (6C-6E) of files (F) corresponding to said programs (5C-5E), in such a way as to permit downloading of said audio and/or video files (F) by means of said trains (6C-6E).

7. The system as claimed in claim 6, characterized in that said audio and/or video programs (5C-5E) being carriers of link signals (24) tied with said trains (6C-6E), the means of extraction (12C-12E) are designed to extract said link signals (24).

8. The system as claimed in one of claims 6 or 7, characterized in that said receiver (1) comprises a digital decoder and a switching block (35) intended to toggle said decoder from at least one of said audio and/or video programs (5E) to the train (6E) of files (F) corresponding to said audio and/or video program when the triggering means (16E) are activated by the enabling means (14) and to toggle said decoder from said train (6E) to said program (5E) when the downloading of said file (F) associated with said program is completed.

9. The system as claimed in any one of the preceding claims, characterized in that it comprises means (13) of production of messages addressed to a user, said messages indicating to said user during receptions of said audio and/or video programs (5) that the enabling means (14) can be used.

10. The system as claimed in any one of the preceding claims, characterized in that it comprises means of ordering recording (15) on the recording medium (4), of the downloaded audio and/or video files (F), said means of ordering recording (15) being designed to supplement said files (F) with details regarding the corresponding audio and/or video programs (5) and/or regarding conditions of downloading of said files (F).

11. A device (21A) for broadcasting audio and/or video programs (5A), characterized in that it comprises means of incorporation (22) into said audio and/or video programs (5A) of signals (23) identifying audio and/or video files (F) corresponding to said programs,
said device preferably being intended to cooperate with a system (3) for ordering files (F) in accordance with one of claims 3 or 4.

12. A transmission assembly (28) for transmitting trains (6C-6E) of audio and/or video files (F), characterized in that it comprises:
means of transmission (25) of trains (6C-6E) of audio and/or video files (F) corresponding to transmitted audio and/or video programs (5C-5E),
and means of synchronization (26) cooperating with the means of transmission (25), and capable of managing the transmission of said files (F) in such a way that the trains (6C-6E) of files (F) are transmitted at the same time as said corresponding programs (5C-5E),
said device preferably being intended to cooperate with a system (3) for ordering files (F) in accordance with any one of claims 6 to 8.

13. The transmission assembly (28) as claimed in claim 12, characterized in that it is designed to transmit in a loop during the broadcasting of each of said programs (5C-5E), said audio and/or video file (F) corresponding to said program.

14. The transmission assembly (28C) as claimed in one of claims 12 or 13, characterized in that it comprises means of broadcasting (21C) of said audio and/or video programs (5C) and means of multiplexing (27) cooperating with the means of transmission (25) of the trains (6C) of files (F) and the means of broadcasting (21C) of the programs (5C), intended to multiplex the audio and/or video programs (5C) and the corresponding files (F) on same transport streams (7).

15. A software product intended to be integrated into a receiver (1) of audio and/or video programs (5) broadcast in real time, characterized in that said software product contains extraction functionalities for information relating to audio and/or video files (F) corresponding to said audio and/or video programs (5), capable of embodying the means of extraction (12) of information of an ordering system (3) in accordance with any one of claims 1 to 10.

16. An audio and/or video program (5), characterized in that it is a carrier of signals (23) identifying at least one audio and/or video file (F) corresponding to said program (5),
said audio and/or video program preferably being obtained by means of a broadcasting device (21A) in accordance with claim 10 and/or intended for an ordering system (3) in accordance with one of claims 3 or 4.

17. A transport stream (7) characterized in that it contains a multiplexing of at least one audio and/or video program (5C) and of at least one audio and/or video file (F) corresponding to said program (5C),
said transport stream (7) preferably being obtained by means of a transmission assembly (28C) in accordance with claim 14 and/or intended for an ordering system (3) in accordance with claim 7.

18. A receiver (1) of audio and/or video programs (5), characterized in that it comprises an ordering system (3) in accordance with any one of claims 1 to 10.

19. A receiver (1) as claimed in claim 18, characterized in that it is chosen from among an RF or digital television, an RF or digital radio, a home computer and a digital decoder.

20. The receiver (1) as claimed in one of claims 18 or 19, characterized in that it comprises a management system (18) for managing the files (F) downloaded into the recording medium (4), said management system (18) being designed:
to automatically add the downloaded files (F) to at least one list consultable by a user,
to permit deletions of the files (F) contained in said list, by said user,
and to permit reading of each of the files (F) contained in said list, on request from said user.

21. A process for broadcasting an audio and/or video program (5A), characterized in that at least one signal (23) identifying at least one audio and/or video file (F) corresponding to said program (5A) is incorporated into said program (5A) before broadcasting,
said process preferably being intended for an ordering system (3) in accordance with one of claims 3 or 4.

22. A process for broadcasting an audio and/or video program (5C), characterized in that before broadcasting, said audio and/or video program (5C) is multiplexed with at least one audio and/or video file (F) corresponding to said program (5C),
said process preferably being intended for an ordering system (3) in accordance with claim 7.
